(19) United States
(12) Patent Application Publication
(10) Pub. No.: US 2023/0253792 A1
(43) Pub. Date: Aug. 10, 2023

(54) METHOD FOR THE REDUCTION IN THE ELECTRICITY CONSUMPTION OF A LOAD

(71) Applicant: DEVELOPMENT OF HUMAN GENIUS LTD, LONDON NW11 8NA (GB)

(72) Inventors: FILIPPO ANTONIO NICOLETTI, RIESI (IT); SALVATORE GIUSEPPE NICOLETTI, RIESI (IT); CALOGERO CALCAGNO, RIESI (IT)

(21) Appl. No.: 17/777,866

(22) PCT Filed: Nov. 16, 2020
(86) PCT No.: PCT/EP2020/082306

§ 371 Date: May 18, 2022

(30) Foreign Application Priority Data
Nov. 22, 2019 (IT) 102019000021858

(51) Int. Cl. H02J 3/16; H02J 3/18

(52) U.S. Cl. CPC H02J 3/16; H02J 3/1821; H02J 2310/60; H02J 2310/20

(57) ABSTRACT

A method for the reduction in the electricity consumption of an electrical load (2) placed along an electric line (3), said method comprising the steps of: —determining a phase shift existing between the current and voltage along the electric line (3); —implementing the following procedure if said phase shift falls within a predetermined range: i) performing an interruption of current to the electrical load (2) of a duration less than a predetermined value; ii) modifying an electrical characteristic of an additional electrical load (6) as a function of the phase shift; iii) putting or maintaining said additional electrical load (6) in parallel with the electrical load (2).

### TECHNICAL FIELD

The present invention relates to a method for the reduction in the electricity consumption of a load.

Such load can be for example a single household appliance, a group of household appliances or an entire electric line, placed by way of example downstream of an electrical panel (for example, the electric line of an entire house).

### PRIOR ART

Alternating current electric lines are known. In industrial applications involving inductive loads (motors, transformers, etc.) and in which the electrical load parameters and the operating modes are constant over time, it is known to perform a power factor correction of the load. To do this, a capacitor bank with a fixed and predetermined capacitance is positioned parallel to the load.

This power factor correction allows to reduce or zero the reactive power associated with the presence of the inductive load and therefore the phase shift between the voltage and current. The reactive power does not generate mechanical work, but still induces the passage of electric current (reactive) through the electric line. Such reactive current generates dissipations due to the Joule effect without increasing the active power. Moreover, such dissipations are proportional to the square of the current. In addition, the reactive current is paid to the electricity supplier.

It is therefore advantageous to minimise the reactive current. A drawback of the known solution is linked to the fact that, if the absorption is variable over time, always positioning the same capacitor in parallel cannot cancel the phase shift and in some cases the use thereof can also be counterproductive. In addition, the capacitor banks used to date for these applications have a very high cost. The use thereof therefore does not occur in certain environments, such as the household one.

### OBJECT OF THE INVENTION

In this context, the technical task underpinning the present invention is to provide a method for the reduction in the electricity consumption of a load which economically and reliably overcomes the drawbacks of the prior art as cited above. In particular, it is an object of the present invention to provide a method for the reduction in the electricity consumption of a load which has the maximum flexibility of use.

The technical task set and the objects specified are substantially attained by a method comprising the technical features as set out in one or more of the appended claims.

### BRIEF DESCRIPTION OF THE DRAWINGS

Further characteristics and advantages of the present invention will become more apparent from the indicative and thus non-limiting description of a preferred but not exclusive embodiment of a method which exploits an electric system, as schematically illustrated in the appended drawings, in which:

FIGS. 1 and 2 show alternative schematic views of an apparatus according to the present invention.

### DETAILED DESCRIPTION OF PREFERRED EMBODIMENTS OF THE INVENTION

In the accompanying drawings, reference number 1 indicates an apparatus for the reduction in the electricity consumption of an electrical load 2.

Such apparatus 1 comprises means 4 for determining the phase shift between the current and voltage along an electric line 3 in which the electrical load 2 is placed; such electric line 3 allows the power supply of the electrical load 2. The electric line 3 is an alternating current or direct current line.

The means 4 for determining the phase shift comprises, for example, a phase meter (in the technical jargon sometimes called power factor meter).

Suitably, the apparatus 1 comprises an additional load 6. The additional load 6 can be connected in parallel to said electrical load 2. In the course of the present discussion, parallel connection means a connection which is electrically parallel (thus no reference is made to a geometric but electrical condition). The additional load 6 has at least one modifiable electrical characteristic, in particular the capacitance is adjustable. The capacitance is understood according to the common definition as the relationship between the load Q and the difference in potential. It is typically measured in Farad. The additional load 6 suitably comprises a plurality of accumulators of electric charge. Suitably, the accumulators have variable capacitance. The accumulators are therefore capacitors. They can also possibly be defined as “micro-capacitors”. The capacitance of the additional load 6 is adjustable by varying the number and/or electrical capacitance of the accumulators connected in parallel to the electrical load 2. In an exemplary solution the accumulators are equal to a number comprised between 10 and 15. In fact, by adjusting the capacitance of the individual accumulators and connecting or disconnecting a specific combination of such accumulators in a suitable manner, it is possible to cancel or in any case minimise the phase shift.

The apparatus 1 further comprises means 5 for interrupting the electric current along the electric line 3. The means 5 for interrupting the electric current allows an interruption of the current for an extremely short time (it can therefore be referred to as micro-interruption). Such interruption typically lasts less than 0.1 milliseconds, suitably comprised between 0.001 milliseconds and 0.1 milliseconds. In the preferred solution, such interruption is comprised between 0.009 and 0.012 milliseconds. Therefore, the duration of this current interruption is such as not to compromise the correct operation of the electrical load 2. The latter will not even sense the interruption.

Suitably, the interruption means 5 comprises a plurality of switches (typically micro-switches). By way of example, they could be comprised between 4 and 8. Suitably, the open/closed combination of the switches not only allows to interrupt the electric current along the electric line 3, but also to connect the desired accumulators in parallel to the electrical load 2 to reduce (or rather to cancel) the phase shift.

The apparatus 1 comprises control means 7 which modifies at least one electrical characteristic (the capacitance) of said additional load 6 as a function of at least the phase shift detected by said determination means 4. For example, the control means 7 comprises a control unit. The control means 7 comprises a firmware. The additional load 6 is a capacitor with adjustable capacitance (which can take on the suitable value from time to time for a power factor correction of the current and voltage). The capacitance is adjusted by varying the number and/or capacitance of the accumulators in parallel to the electrical load 2.

In a non-preferred alternative solution the additional load 6 is an inductor and the adjustable electrical characteristic in such case could be an inductance.

Suitably the apparatus 1 comprises a casing inside which the additional load 6 is placed, the control means 7 and appropriately the phase shift determination means 4 and/or the interruption means 5. Suitably the additional load 6 and/or the control means 7 and/or the interruption means 5 are placed on an electronic board 70.

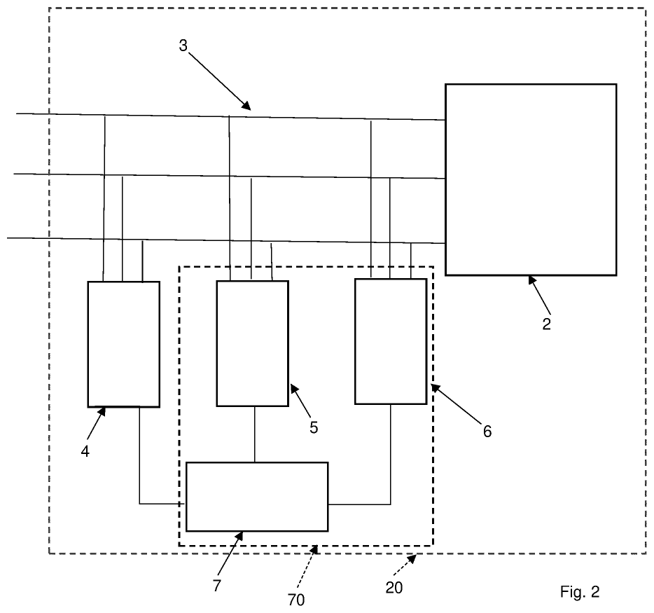

In a particular embodiment at least the additional load 6 and/or the control means 7 and/or the interruption means 5 are placed in a household appliance 20 (see FIG. 2). Such household appliance 20 defines the electrical load 2.

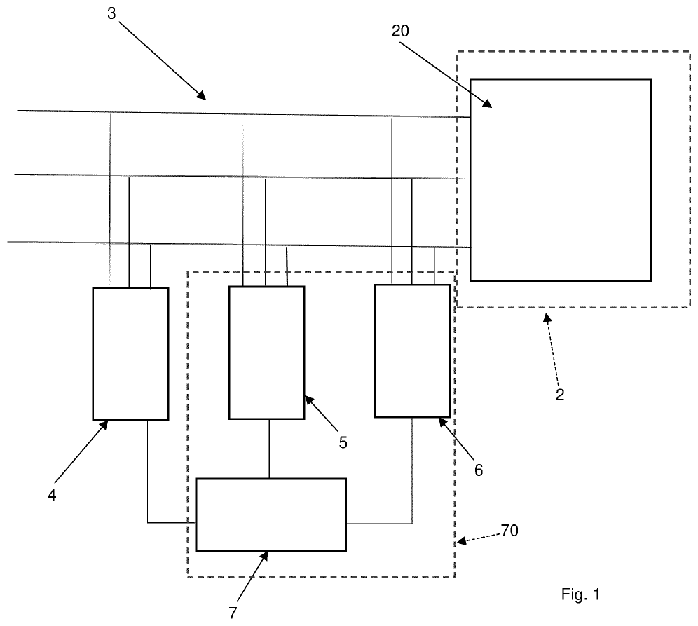

In an alternative solution (see for example FIG. 1) at least the additional load 6 and/or the control means 7 and/or the interruption means 5 are placed in an electrical panel or upstream of the electrical load 2. In this case, the electrical load 2 comprises/is what is placed downstream of said casing, for example the electrical system of a building or a house (which in turn comprises one or more household appliances).

The object of the present invention is a method for the reduction in the electricity consumption of an electrical load 2 placed along an electric line 3. Such method is suitably implemented by an apparatus 1 having one or more of the features described previously.

Such electrical load 2 is supplied by alternating current. This is suitably carried out through the electric line 3.

The method comprises the step of determining a phase shift existing between the current and voltage along the electric line 3. Such phase shift is typically measured by a phase meter. The phase shift is repeatedly measured, for example at a frequency comprised between 1 and 100 nanoseconds.

Suitably the method comprises implementing a power factor correction procedure if said phase shift falls within a predetermined range. Such predetermined range could be modifiable (for example at the discretion of the installer). In a preferred, but not limiting solution, such a predetermined range corresponds to a range comprising all the values that are measurable and different from a null phase shift. Suitably, said predetermined range is entered as soon as a phase shift is measured (the start of the power factor correction in this case could be a function of the sensitivity of the system for detecting the phase shift).

In a particular construction solution, such predetermined range could be linked to preset values, for example if the cosine of the phase shift is less than 0.98 or another user-defined parameter. The procedure comprises the step of performing an interruption of current to the electrical load 2. Suitably, such interruption is temporary. Suitably, such interruption is of predetermined duration, typically less than a predetermined value. Such predetermined value is suitably less than or equal to 0.1 milliseconds, suitably less than or equal to 0.05 milliseconds, preferably it is 0.01 milliseconds.

Suitably, the procedure comprises the step of modifying an electrical characteristic of an additional electrical load 6 as a function of the phase shift. This is to cancel or in any case minimise such phase shift. The procedure also comprises the step of putting or maintaining said additional electrical load 6 in parallel with the electrical load 2.

Hence the procedure comprises the step of modifying said at least one electrical characteristic of said additional load 6 as a function of at least the phase shift. This suitably occurs before or at the same time as the step of connecting the additional load 6 in parallel to the electrical load 2. In this manner the additional load 6 will be able to fully or almost completely compensate the phase shift.

The additional electrical load 6 comprises a plurality of accumulators of electric charge to be placed in parallel with the load 2 for the power factor correction. The step of modifying an electrical characteristic comprises the step of modifying the capacitance of at least one of said accumulators to place (or placed) in parallel with the electrical load 2 and/or the number of accumulators to place (or placed) in parallel with the electrical load 2.

Therefore, the accumulators are always the same, but are suitably connected or disconnected from being parallel with the electrical load 2.

The additional load 6 therefore has a variable capacitance depending on the number and/or type of micro-accumulators connected in parallel to the electrical load 2; said at least one electrical characteristic modifiable as a function of at least the phase shift comprising/being the capacitance.

In particular, the additional load 6 has a variable capacitance. The variable characteristic (adjustable) of the load 6 as a function of at least the phase shift is at least the capacitance (possibly it is only the capacitance). Suitably, the additional load 6 thus comprises at least one variable capacitance element (suitably a capacitor).

Hence before or simultaneously with the step of connecting the additional load 6 in parallel to the electrical load 2, the electrical characteristic of the additional load 6 which is modified is the capacitance.

Suitably, the additional load 6 is connected in parallel to the electrical load 2 at least partially simultaneously with the interruption of current to the electrical load 2. If necessary, the additional load 6 could remain connected in parallel to the electrical load 2 exactly at the same time as the current interruption period. In this regard, suitable interruption means intervenes which advantageously comprises a plurality of micro-switches which simultaneously interrupt the electric current along the electric line 3 and connect the electrical load 2 with at least a part of the accumulators in order to eliminate or in any case minimise the phase shift.

During operation, the additional load 6 does not always remain connected in parallel to the electrical load 2. Suitably, this only occurs for the power factor correction.

The method comprises the step of determining the effective voltage, effective intensity of the current and pulsation of the current or voltage wave that supplies the electrical load 2. The electrical characteristic of the additional load 6 is suitably modifiable as a function not only of the phase shift but also of the effective voltage, the effective current and the wave pulsation of the current that supplies the electrical load 2.

In the preferred solution, the capacitance of the additional load 6 (before or at the same time as the step of putting it in parallel with the electrical load 2) is adjusted as a function of the phase shift, the effective voltage, the effective intensity of the current and the pulsation of the current wave that supplies the electrical load 2 (or in any case of parameters associated with and derivable therefrom).

The step of modifying at least one electrical characteristic of said additional load 6 as a function of at least the phase shift comprises the sub-step of setting the capacitance of the additional load 6 equal to Q/(ω·V²), wherein:

Q is the reactive power and is equal to: V·I·cos(φ)·tg(φ)
V is the effective voltage;
I is the effective intensity of the current;
φ is the phase shift between the voltage and current;
ω: is the pulsation of the current or voltage wave.

The phase shift φ is typically measured by the phase meter described above.

The step of determining the pulsation w of the current or voltage wave comprises the step of measuring a plurality of points of this wave and reconstructing the equation of the sine/cosine wave. The effective voltage and the effective intensity of the current are determined starting from the measurements.

Suitably, the step of measuring the effective voltage and/or the effective intensity of the current and/or the pulsation occurs more frequently when a phase shift of the current is detected with respect to the voltage.

The procedure described above allows the power factor correction of the load. In order to make this power factor correction more precise, the method suitably comprises the step of choosing the electrical components of the load 2 whose electricity consumption is to be optimised (for example, in the case where the load 2 is a washing machine, it could be a water pump and an electric motor driving a rotating drum, leaving out the minor components such as displays and other components).

The method also provides an iterative cycle comprising the step of constructing a nodal matrix G·V=I suitably adopting a mathematical model for finite differences (wherein G is a descriptive matrix of the characteristic curve V−I of the components of the load 2 in question, V and I are the voltage and current matrices). For the components with non-linear characteristic curves V−I, a linear model is previously generated; therefore, where the voltage across a component does not have a linear behaviour with respect to the current passing through the component, for example, the line tangent to the characteristic curve of the component can be considered at the work point. Various mathematical models of a known type are possible in order to define a linear model of a non-linear component.

The set of equations is solved by adopting as input parameters for example voltage and current values measured along the electric line 3. For example, the equations are solved with respect to the voltages and it occurs if the difference with respect to the input value of the voltage is greater than a predetermined error. If not, the iterative cycle is repeated using the new voltage values as input parameters. The process is continued iteratively until convergence. Such nodal matrix is monitored over time. If changes over time were detected in this nodal matrix G, it means that changes in operation have occurred. Accordingly, the method comprises the step of recalculating the capacitance which must be assumed by the additional load 6 Q/(ω·V²) as described above. In this manner, the correct and updated value is obtained.

Advantageously, the step of performing an interruption of current occurs with a delay after the step of determining said phase shift has detected that said phase shift is in said predetermined range. Such delay allows to maximise the power factor correction, limiting the duration of said interruption of current.

Suitably, the method involves repeatedly determining the existing phase shift between the voltage and current even during the implementation of said procedure; the step of connecting an additional load 6 along the electric line ends with a predetermined delay starting from the moment in which it is determined (through ad hoc measurements) that the phase shift is equal to 0. Suitably, such predetermined delay is less than or equal to 0.06 nanoseconds.

The step of implementing said power factor correction procedure is performed by control means 7.

The control means 7 suitably comprises a firmware.

The control means 7 therefore calculates the value of the variable electrical characteristic (usually the capacitance, but in some particular solutions it could be the inductance) which said additional load 6 must assume before or at the same time as the step of putting it in parallel with the electrical load 2. In the preferred solution, the control means 7 determines the value of the capacitance which the accumulators of electric charge put in parallel with the electrical load 2 must assume. This is equivalent to putting an additional load 6 having a capacitance which is equal to the sum of the capacitances of the individual accumulators in parallel with the electrical load 2. Suitably, the accumulators are placed in parallel with each other (consequently the equivalent capacitance of the accumulators is equal to the sum of the capacitances of the individual accumulators).

Suitably the control means 7 is placed in a household appliance 20 (see FIG. 2). In this case, said electrical load 2 and said additional load 6 are placed in said household appliance 20. In this case, the method typically allows a power factor correction of only the household appliance 20. This allows the placing on the market of household appliances provided with an excellent energy class.

Possibly, but not necessarily, the control means 7 could be placed in the electrical panel (see FIG. 1). In this case, the electrical load 2 is the set of what is downstream of the electrical panel.

Suitably, the step of modifying an electrical characteristic of an additional electrical load 6 as a function of the phase shift prevents the value assumed by such electrical characteristic from being such as to resonate the system. For example, if the control means 7 determines that the capacitance of the additional load 6 necessary to cancel the phase shift is such as to resonate the system comprising the electrical load 2, then the control means 7 would modify the capacitance assumed by the accumulators placed in parallel with the additional load 6 by a predetermined amount, for example 0.1 micro-Farad (to avoid resonance).

The present invention achieves important advantages.

First of all, it allows a reduction in electricity consumption which results in significant economic savings (from 5% to 45% on the general consumption of the system and on the energy bill—based on the tests performed by the Applicant). Furthermore, the apparatus according to the present invention has a purchase and maintenance cost which can be quickly recovered from such savings. It can also be integrated into household appliances to improve the energy class thereof.

The apparatus according to the present invention further provides additional important advantages.
reduction in non-functional harmonics and power peaks required by the system with consequent reduction of the stress and consumption of machinery;
optimisation and management of current flow as a function of real needs with consequent reduction of thermal dispersion and energy inefficiencies of the system;
rebalancing of energy transmission over phases and optimisation of energy distribution;
adjustment of the output voltage, adapting it to the characteristics of the system;
improvement of the phase shift, reduction of reactive power and alignment of the system with network parameters;
reduction of maintenance costs, safeguarding household appliances from network disturbances and increasing the life span thereof;
presence of passive forced BY-PASS: in the event of a fault, the system is self-excluded without causing interference or shutdown of the user system, in less than 1 millisecond.

A significant advantage of the present invention is that of acting on the phase shift of the load. In particular, it is constantly measured and continuously updated to the lowest possible value. The electrical meter of the entity which supplies the energy therefore has the opportunity to immediately notice the improvement of the phase shift.

The invention as it is conceived is susceptible to numerous modifications and variants, all falling within the scope of the inventive concept characterised thereby. Further, all the details can be replaced with other technically equivalent elements. In practice, all the materials used, as well as the dimensions, can be any whatsoever, according to need.

1. A method for the reduction in the electricity consumption of an electrical load (2) placed along an electric line (3), said method comprising the steps of:
determining a phase shift existing between the current and voltage along the electric line (3);
if said phase shift falls within a predetermined range, implementing a power factor correction procedure comprising the sub-steps of:
i) performing a temporary interruption of current to the electrical load (2);
ii) modifying an electrical characteristic of an additional electrical load (6) as a function of the phase shift;
iii) putting or maintaining said additional electrical load (6) in parallel with the electrical load (2).

2. The method according to claim 1, characterised in that said additional load (6) has a variable capacitance; said at least one characteristic that can be modified as a function of at least the phase shift comprises/is the capacitance.

3. The method according to claim 1, characterised in that said additional electrical load (6) comprises a plurality of accumulators of electric charge which can be connected in parallel to the electrical load (2) for the power factor correction; the step of modifying an electrical characteristic comprises the step of modifying the capacitance of at least one of said accumulators to be put in parallel with the electrical load (2) and/or the number of accumulators to be put in parallel with the electrical load (2).

4. The method according to claim 1, characterised in that it determines the effective voltage, effective intensity of the current and pulsation of the current or voltage wave that supplies the electrical load (2); said electrical characteristic of the additional load (6) being modifiable as a function of the phase shift as well as of the voltage, current and a pulsation of the voltage or current wave that supplies the electrical load (2).

5. (canceled)

6. The method according to claim 4, characterised in that the step of determining the pulsation of the current or voltage wave comprises the step of measuring a plurality of points of this wave and reconstructing the equation of the sine/cosine wave.

7. The method according to claim 1, characterised in that the step of performing an interruption of current occurs with a delay after the step of determining said phase shift has detected that said phase shift is in said predetermined range.

8. The method according to claim 1, characterised in that it repeatedly determines the phase shift existing between voltage and current even during the implementation of said procedure; the step of making or maintaining the additional load (6) in parallel with the load (2) ends with a predetermined delay after the phase shift determined is equal to 0.

9. The method according to claim 1, characterised in that said predetermined range in which said procedure is implemented corresponds to a phase shift other than 0.

10. The method according to claim 1, characterised in that the step of implementing said procedure is performed by control means (7) placed in a household appliance (20), said electrical load (2) and said additional load (6) being placed in said household appliance (20).

11. An apparatus for the reduction of the electricity consumption of a load comprising:
determination means (4) for determining the phase shift between current and voltage along an electric supply line (3) of the load (2);
means (5) for interrupting the electric current along the electric line (3);
an additional load (6), connectable in parallel to said load, and having at least one modifiable electrical characteristic;
control means (7) that modifies at least one electrical characteristic of said additional load (6) as a function of at least the phase shift detected by said determination means (4).

12. The method according to claim 2, characterised in that it determines the effective voltage, effective intensity of the current and pulsation of the current or voltage wave that supplies the electrical load (2); said electrical characteristic of the additional load (6) being modifiable as a function of the phase shift as well as of the voltage, current and a pulsation of the voltage or current wave that supplies the electrical load (2).

13. The method according to claim 12, characterised in that the step of modifying at least one electrical characteristic of said additional load (6) as a function of at least the phase shift comprises the sub-step of setting said variable capacitance equal to Q/(ω·V²) wherein:
Q is the reactive power and is equal to: V·I·cos(φ)·tg(φ)
V is the effective voltage;
I is the effective intensity of the current;
φ is the phase shift between the voltage and current.
